(19) United States
(12) Patent Application Publication
(10) Pub. No.: US 2018/0328257 A1
(43) Pub. Date: Nov. 15, 2018

(54) JOINT ASSEMBLY

(71) Applicant: Tenneco Automotive Operating Company Inc., Lake Forest, IL (US)

(72) Inventors: Zachary Panak, Grass Lake, MI (US); Trent Hudson, Grass Lake, MI (US)

(21) Appl. No.: 16/045,184

(22) Filed: Jul. 25, 2018

(51) Int. Cl. F01N 13/18; F16L 23/18; F16L 23/032

(52) U.S. Cl. CPC F01N 13/1827; F01N 13/10; F16L 23/032; F16L 23/18

(57) ABSTRACT

A joint assembly includes a manifold flange having a clearance portion. The clearance portion is inclined outwards relative to a longitudinal axis of the manifold flange. The joint assembly includes a pipe adapted to be at least partially inserted into the manifold flange. The pipe includes at least one protrusion extending from an outer surface of the pipe. The clearance portion of the manifold flange allows insertion of the at least one protrusion into the manifold flange. The joint assembly also includes a pipe flange mounted on the pipe. The pipe flange is adapted to be coupled to the manifold flange. The joint assembly further includes a gasket mounted on the pipe. The gasket is adapted to be received in the clearance portion of the manifold flange. The at least one protrusion retains the gasket on the pipe during insertion of the pipe into the manifold flange.

### TECHNICAL FIELD

The present disclosure relates to a joint assembly. More particularly, the present disclosure relates to the joint assembly associated with an internal combustion engine.

### BACKGROUND

An internal combustion engine includes a number of joints for coupling two conduits, such as an exhaust manifold and an exhaust pipe, an intake manifold and an intake pipe, or any other conduits associated with the engine. The joint may include one or more of flanges, sealing elements, fastening elements, and so on. In many situations, limited visibility and/or space may be available around the engine. This may limit ease of assembly of the joint, such as during engine assembly, service, and/or maintenance.

For example, limited space around the joint location due to surrounding components, such as a heat shield, electrical lines, fluid lines, fuel lines, overall engine geometry, other engine components, and so on, may limit correct positioning and assembly of the connecting elements, in turn, limiting ergonomic working position for an assembler. In some situations, limited visibility may lead to missing or falling off of some connecting elements, such as sealing elements, fastening elements and so on, in turn, leading to increased assembly time and costs. Hence, there is a need for an improved joint assembly for such applications.

Given description covers one or more above mentioned problems and discloses a method and a system to solve the problems.

### SUMMARY

In an aspect of the present disclosure, a joint assembly is provided. The joint assembly includes a manifold flange. The manifold flange includes an inner surface that defines an opening. The inner surface includes a clearance portion disposed adjacent to an insertion end of the manifold flange. The clearance portion is inclined outwards relative to a longitudinal axis of the manifold flange. The joint assembly includes a pipe adapted to be at least partially inserted into the opening of the manifold flange from the insertion end. The pipe has a hollow cylindrical shape at least partly along a length of the pipe. The pipe includes at least one protrusion extending from an outer surface of the pipe. The at least one protrusion is disposed proximal to an end of the pipe. The clearance portion of the manifold flange allows insertion of the at least one protrusion into the opening of the manifold flange. The joint assembly also includes a pipe flange mounted on the pipe proximal to the end of the pipe. The pipe flange is adapted to be coupled to the manifold flange after insertion of the pipe into the opening of the manifold flange. The joint assembly further includes a gasket mounted on the pipe between the pipe flange and the at least one protrusion. The gasket is adapted to be received in the clearance portion of the manifold flange. The at least one protrusion retains the gasket on the pipe during insertion of the pipe into the manifold flange.

Other features and aspects of this disclosure will be apparent from the following description and the accompanying drawings.

### BRIEF DESCRIPTION OF DRAWINGS

FIG. 1 is a cross-sectional view of a joint assembly in a disassembled position, according to an aspect of the present disclosure;

FIG. 2 is a perspective view of a pipe and a pipe flange of the joint assembly of FIG. 1, according to an aspect of the present disclosure;

FIG. 3 is a cross-sectional view of a gasket of the joint assembly of FIG. 1, according to an aspect of the present disclosure;

FIG. 4A is a perspective view of the gasket of FIG. 3 mounted on the pipe of FIG. 2, according to an aspect of the present disclosure;

FIG. 4B is a front view of the gasket of FIG. 3 mounted on the pipe of FIG. 2, according to an aspect of the present disclosure; and

FIG. 5 is a cross-sectional view of the joint assembly in an assembled position, according to an aspect of the present disclosure.

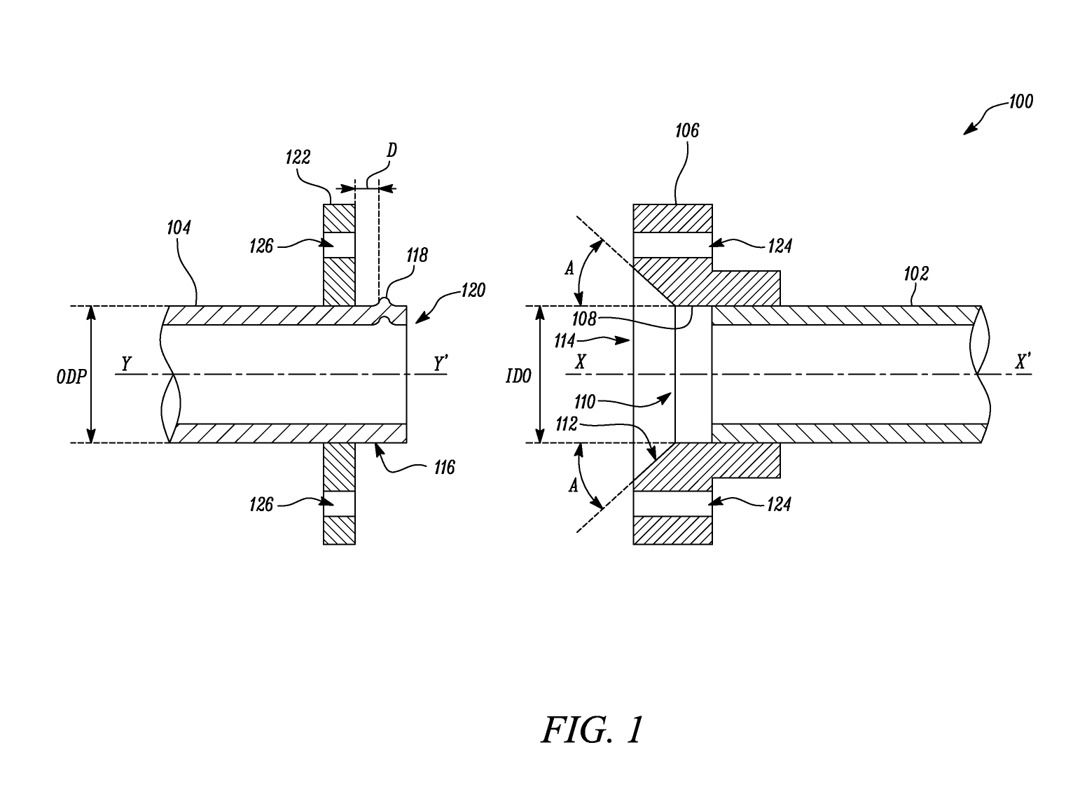

### DETAILED DESCRIPTION

Wherever possible, the same reference numbers will be used throughout the drawings to refer to same or like parts. Referring to FIG. 1, a joint assembly 100 in a disassembled state is illustrated. The joint assembly 100 will be hereinafter interchangeably referred to as the “assembly 100”. The assembly 100 is associated with an internal combustion engine (not shown). More specifically, the assembly 100 is provided to couple two sections of an exhaust system of the engine, such as an exhaust manifold 102 and an exhaust pipe 104. In other situations, the assembly 100 may be provided to couple an intake manifold (not shown) and an intake pipe (not shown), or two sections of an aftertreatment system (not shown) of the engine, or any other sections of the engine.

The assembly 100 includes a manifold flange 106 provided on the exhaust manifold 102. The manifold flange 106 includes a longitudinal axis X-X′ thereof. The manifold flange 106 includes an inner surface 108. The inner surface 108 defines an opening 110 of the manifold flange 106. Also, the inner surface 108 defines an inner diameter “IDO” of the opening 110. The inner surface 108 also includes a clearance portion 112. The clearance portion 112 is disposed adjacent to an insertion end 114 of the manifold flange 106. In the illustrated figure, the clearance portion 112 is inclined outwards relative to the longitudinal axis X-X′. As such, the clearance portion 112 defines an angle “A” with respect to the longitudinal axis X-X′. A value of the angle “A” ranges from 40 degrees (°) to 60° and may vary based on application requirements.

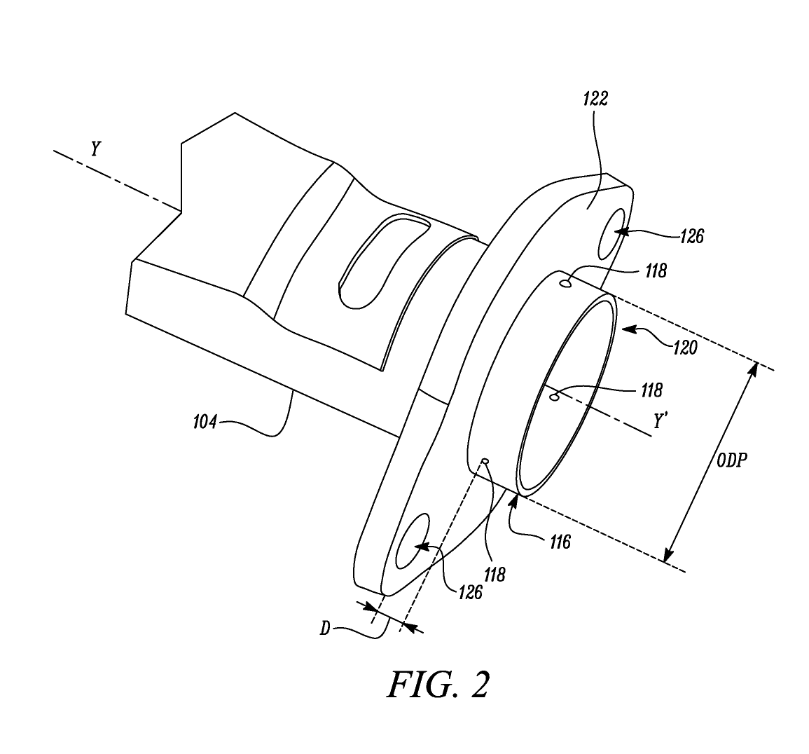

Referring to FIGS. 1 and 2, the assembly 100 includes the exhaust pipe 104 defining an outer surface 116 thereof. The outer surface 116 defines an outer diameter “ODP” of the exhaust pipe 104. The exhaust pipe 104 also defines a longitudinal axis Y-Y′ thereof. The exhaust pipe 104 has a substantially hollow cylindrical shape at least partly along a length of the exhaust pipe 104. The exhaust pipe 104 is adapted to be at least partially inserted into the opening 110 of the manifold flange 106 from the insertion end 114. The exhaust pipe 104 includes one or more protrusions 118 extending from the outer surface 116. Each of the protrusions 118 is disposed proximal to an end 120 of the exhaust pipe 104.

In the illustrated figures, the exhaust pipe 104 includes three protrusions 118 provided on the outer surface 116, such that each of the protrusions 118 is disposed circumferentially spaced apart with respect to one another. In other situations, the exhaust pipe 104 may include single or multiple protrusions 118 provided on the outer surface 116, based on application requirements. Also, in the illustrated figures, each of the protrusions 118 is a dimple extending away from the outer surface 116 of the exhaust pipe 104. The dimple may have any suitable shape, such as hemispherical, polyhedral, conical, and so forth. In some situations, one or more of the protrusions 118 may be tabs extending away from the outer surface 116 of the exhaust pipe 104.

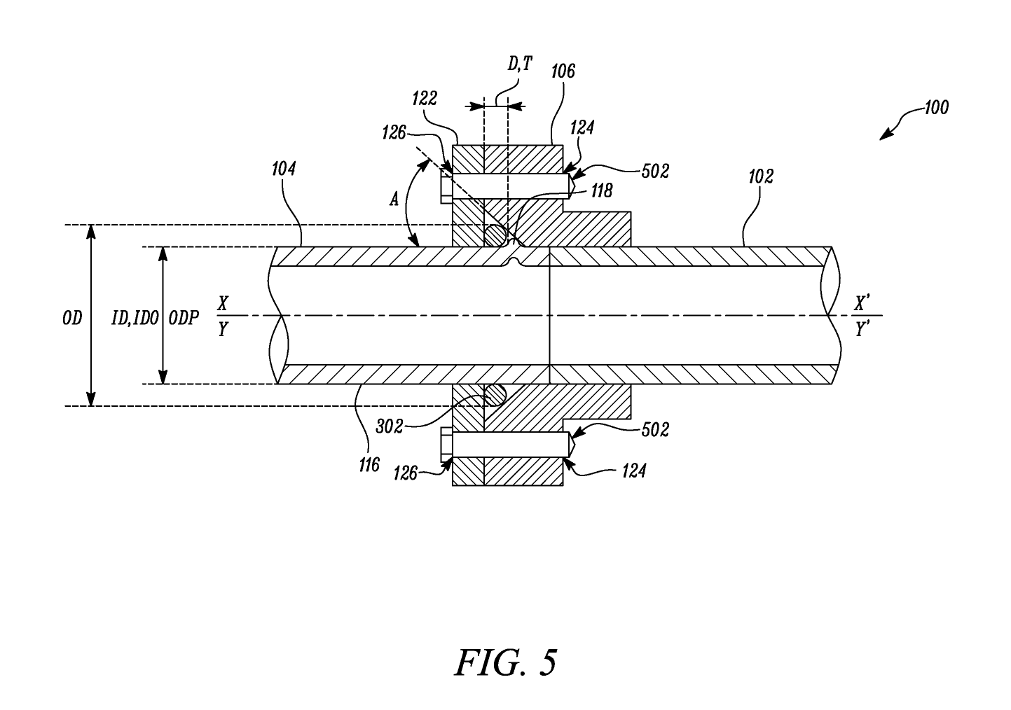

The assembly 100 also includes a pipe flange 122 mounted on the exhaust pipe 104. The pipe flange 122 is disposed proximal to the end 120 of the exhaust pipe 104 at a distance “D” from each of the protrusions 118. The pipe flange 122 is adapted to be coupled to the manifold flange 106 after insertion of the exhaust pipe 104 into the opening 110 of the manifold flange 106. As such, the pipe flange 122 is adapted to couple the exhaust pipe 104 to the exhaust manifold 102 via the manifold flange 106. The pipe flange 122 may be removably coupled to the manifold flange 106 using any coupling method, such as mechanical fasteners, welding, and the like. In an example, the pipe flange 122 may be coupled to the manifold flange 106 by multiple nut and bolt assemblies 502 (shown in FIG. 5). The bolts may be inserted into respective apertures 124 of the manifold flange 106 and respective apertures 126 of the pipe flange 122.

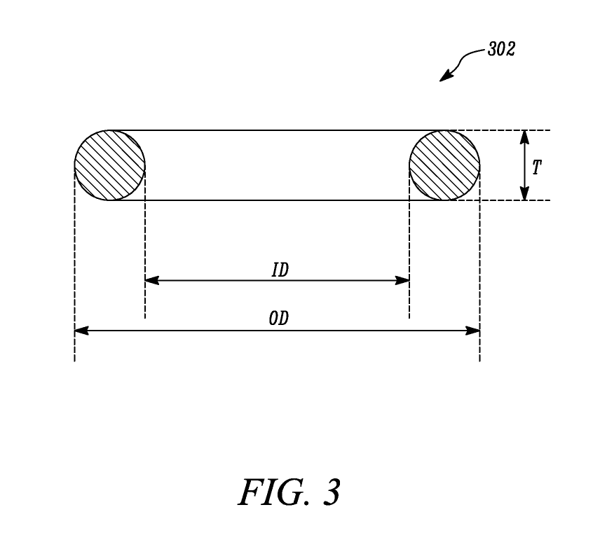

Referring to FIG. 3, a cross-sectional view of a gasket 302 is illustrated. The gasket 302 has a substantially toroidal shape defining an inner diameter “ID”, an outer diameter “OD”, and a thickness “T”. The inner diameter “ID” is equal to or greater than the outer diameter “ODP” of the exhaust pipe 104. Also, the thickness “T” is equal to or smaller than the distance “D” between the pipe flange 122 and each of the protrusions 118. In other situations, the gasket 302 may have any other shape, such as circular.

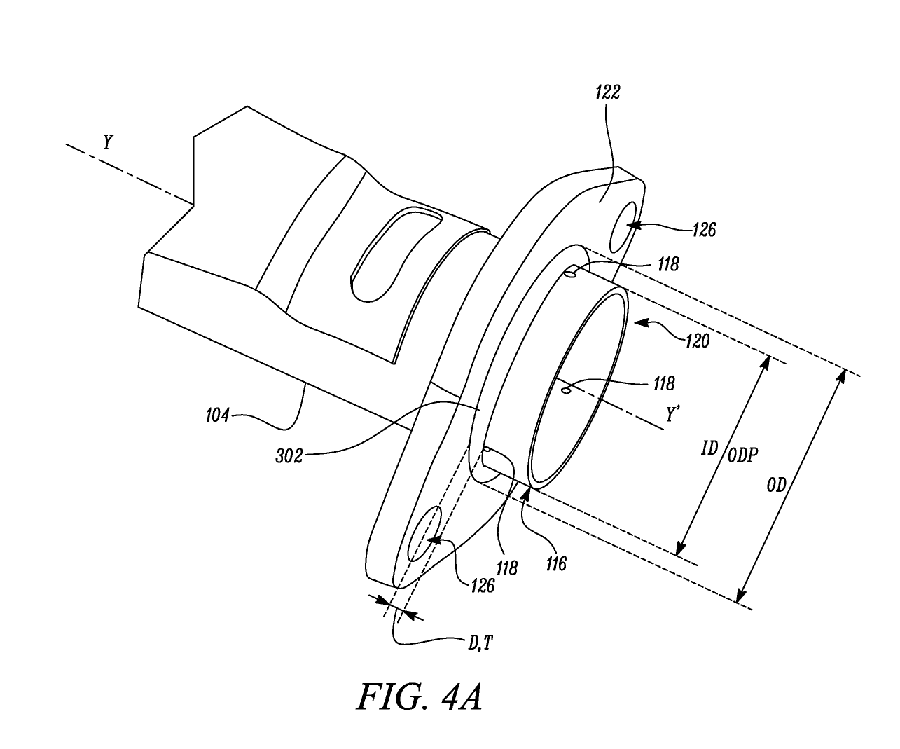

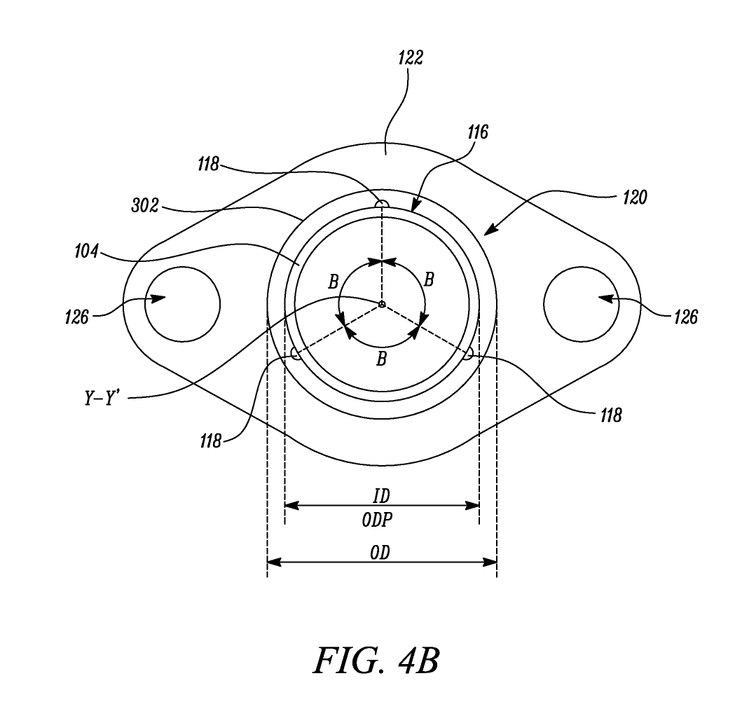

The gasket 302 may be any sealing element, such as an O-ring. The gasket 302 may be manufactured using any sealing material, such as a polymer, a metal, or a combination thereof. Referring to FIGS. 4A and 4B, different views of the gasket 302 mounted on the exhaust pipe 104 are illustrated. The gasket 302 is adapted to be mounted on the exhaust pipe 104 between the pipe flange 122 and the protrusions 118. More specifically, the gasket 302 may be snapped over each of the protrusions 118 to be retained on the exhaust pipe 104. As such, each of the protrusions 118 retain the gasket 302 on the exhaust pipe 104 during insertion of the exhaust pipe 104 into the manifold flange 106. Also, each of the protrusions 118 is disposed at an angle “B” with respect to one another. In the illustrated figures, each of the protrusions 118 is equidistant with respect to one another, such that the angle “B” measures 120°. In some situations, one or more of the protrusions 118 may be spaced at varying angles with respect to one another, based on application requirements.

Referring to FIG. 5, an assembled position of the assembly 100 is illustrated. During assembly 100, the pipe flange 122 is aligned with respect to the manifold flange 106. More specifically, the longitudinal axis Y-Y′ of the exhaust pipe 104 is aligned with respect to the longitudinal axis X-X′ of the manifold flange 106. In some situations, during assembly 100, the longitudinal axis Y-Y′ of the exhaust pipe 104 may be inclined with respect to the manifold flange 106 for ease of assembly. Further, the end 120 of the exhaust pipe 104 along with the protrusions 118 and the gasket 302 is inserted into the opening 110 of the manifold flange 106, such that the pipe flange 122 contacts the manifold flange 106.

As such, the clearance portion 112 of the manifold flange 106 allows insertion of the protrusions 118 into the opening 110 of the manifold flange 106. Accordingly, the gasket 302 is adapted to be received in the clearance portion 112 of the manifold flange 106. Further, the each of the apertures 126 of the pipe flange 122 is aligned with corresponding aperture 124 of the manifold flange 106. The pipe flange 122 is then coupled to the manifold flange 106 via nut and bolt assemblies 502 provided in the apertures 124, 126 to complete the assembly. It should be noted that the outer diameter “OD” of the gasket 302 may be greater than the inner diameter “IDO” of the opening 110. As such, the gasket 302 may be pressed into place after assembly. Accordingly, the gasket 302 may not be required to be retained by the protrusions 118 after assembly.

The assembly 100 provides a simple, effective, and cost efficient method of coupling the exhaust manifold 102 to the exhaust pipe 104. The assembly 100 provides retention of the gasket 302 on the exhaust pipe 104 via the protrusions 118 during assembly. As such, falling off of the gasket 302 from the exhaust pipe 104 during assembly of the assembly 100 is prevented. Accordingly, the exhaust pipe 104 may be easily coupled to the exhaust manifold 102 in a limited space and/or a space with limited visibility. The assembly 100 may be employed for coupling any two sections of pipes, manifold, and/or conduits, based on application requirements. The assembly 100 may be retrofitted in any engine or machine with little or no modification to the existing system.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A joint assembly comprising:
a manifold flange including an inner surface that defines an opening, the inner surface further including a clearance portion disposed adjacent to an insertion end of the manifold flange, wherein the clearance portion is inclined outwards relative to a longitudinal axis of the manifold flange;
a pipe adapted to be at least partially inserted into the opening of the manifold flange from the insertion end, the pipe having a hollow cylindrical shape at least partly along a length of the pipe, the pipe further including at least one protrusion extending from an outer surface of the pipe, wherein the at least one protrusion is disposed proximal to an end of the pipe, and wherein the clearance portion of the manifold flange allows insertion of the at least one protrusion into the opening of the manifold flange;
a pipe flange mounted on the pipe proximal to the end of the pipe, wherein the pipe flange is adapted to be coupled to the manifold flange after insertion of the pipe into the opening of the manifold flange; and
a gasket mounted on the pipe between the pipe flange and the at least one protrusion, wherein the gasket is adapted to be received in the clearance portion of the manifold flange, and wherein the at least one protrusion retains the gasket on the pipe during insertion of the pipe into the manifold flange.
